(19) United States
(12) Patent Application Publication
(10) Pub. No.: US 2024/0264857 A1
(43) Pub. Date: Aug. 8, 2024

(54) Method, System, and User Interface for Operating Focused-Interest, Machine-Learning-Optimized Social Networks

(71) Applicant: Shalabh SAXENA, Fremont, CA (US)

(72) Inventor: Shalabh SAXENA, Fremont, CA (US)

(21) Appl. No.: 18/583,699

(22) Filed: Feb. 21, 2024

Related U.S. Application Data
(63) Continuation-in-part of application No. 17/670,452, filed on Feb. 12, 2022.

(51) Int. Cl. G06F 9/455; G06N 20/00

(52) U.S. Cl. CPC G06F 9/45558; G06N 20/00; G06F 2009/45595

(57) ABSTRACT

A virtual card server comprising a machine intelligence engine such as a Large Language Model (LLM) neural network system. This virtual card server is configured to communicate with a plurality of user computerized devices, receive news feeds, communicate with third-party servers, and implement a virtual card-oriented social network over at least one domain of interest. The machine intelligence engine is trained over the domain(s) of interest and can work with the server to notify social network users about relevant news feed items, as well as to automatically select and promote relevant social network postings about the field of interest. Additionally, users can use the social network to send commands to third-party servers, such as financial and investment transaction servers.

### CROSS-REFERENCE TO RELATED APPLICATIONS

This application is a continuation in part of U.S. patent application Ser. No. 17/670,452, filed Feb. 12, 2022; the entire contents of this application are incorporated herein by reference.

### BACKGROUND OF THE INVENTION

### Field of the Invention

The present invention is for systems, methods, and user interfaces for operating machine-learning-assisted social network systems optimized for specific specialties of interest.

### Description of the Related Art

There are many social networks, like Facebook, LinkedIn, Twitter, etc. Whether through original design intent or evolution, each has been somewhat optimized over time for specific purposes, such as friends'status (Facebook), career updates (LinkedIn), and political news (Twitter). Each network's user interface is also somewhat optimized for these specific purposes. As a result, users tend to gravitate to whichever social network best meets their interests at any given time.

Social networks have made at least some use of simple machine-learning algorithms for many years; however, until recently, these methods were relatively simplistic. For example, prior art social networks often offer methods to “like” or “repost” postings. The computer servers running these social networks keep track of the popularity of such liked or reposed entries and automatically tend to recommend these to other users.

More advanced machine learning methods include Large Language Model approaches such as ChatGPT, GPT-4, CoPilot, LLaMA, and the like. These are discussed in Min et. al., “Recent Advances in Natural Language Processing via Large Pre-Trained Language Models: A Survey,” arXiv: 2111.01243 [cs.CL], November 2021.

Card based user interfaces: Examples of prior art on computer user interfaces configured to facilitate task switching includes Behar et. al., US 2020/0249807 (now U.S. Pat. No. 11,604,566), and other workers.

### BRIEF SUMMARY OF THE INVENTION

In some embodiments, this invention can be a computerized system and method for providing a machine-learning-enhanced social network that is optimized for one or more specific areas of interest.

These areas of interest can vary according to the interests of the social network operators and also user base. Examples of relevant areas of interest include science and technology (e.g. biotechnology, medicine, various areas of chemistry, various areas of physics, and so on). Thus, for example, a social network designed for use by solid-state physicists may have a machine intelligence that comprise an LLM heavily trained in solid-state physics concepts. Similarly, a social network designed for use by physicians may comprise an LLM heavily trained in various medical areas, and so on.

Thus, the systems and methods disclosed herein are intended to handle a wide range of areas of interest, depending upon the specific training of the system's underlying machine intelligence engine (LLM) and the interests of their specific user groups. Finance and investing are topics of general interest. Although, in this disclosure, most of the examples given will be finance and investing-related, it should be understood that these examples are not intended to be limiting.

Regarding user interfaces: Some prior-art social networks provide a relatively free-form graphical user interface, such as a simple text input window with an option also to include images. As will be discussed in more detail, at least for certain specific areas of interest, it can occasionally be useful to provide a more specialized graphical user interface that is optimized for those particular areas of interest. Thus, as will be discussed, in some embodiments, the invention may further comprise a “card” oriented graphical user interface. Here, in addition to some non-limiting financial and investment-related applications, some specific “card-type” graphical user interfaces will also be disclosed.

Expressing the invention on a more general system level format, in some embodiments, the invention may be a computerized server (here called a virtual card server) comprising at least one server processor, server memory, an internet network interface, and a machine intelligence engine, such as an LLM that, often in addition to general purpose LLM training, is also trained for one or more specific domains of interest. That is, the LLM should ideally have enough general-purpose training, often GPT-4 level or above, to understand human language and have a basic understanding of how the world works. Additionally, however, the LLM will be further trained to have high levels of expertise in at least one area of interest, such as the previously discussed solid-state physics or medicine examples, or in finance and investing as another example.

This virtual card server is configured to electronically communicate (usually over the internet network interface) to a plurality of different user computerized devices. Each user computerized device will typically comprise at least one device processor, a device internet interface, and a graphical user interface, such as a touchscreen, display screen with keyboard/mouse, and the like.

In a preferred embodiment, the virtual card server may be configured to handle (e.g., implement a social network) by receiving and transmitting virtual cards comprising news card information. In some embodiments, this news card information can comprise at least one transmitting user identification, at least one receiving user distribution, a title, priority, card payload data, machine-learning-enhanced presentation data, at least one user interest flag, and at least one user command. These virtual cards will often be termed “news cards.” When the topic is related to finance, they may also occasionally referred to in the alternative as “financial cards.”

Here, the virtual card server is typically configured to exchange virtual cards among users by receiving the virtual cards (often previously transmitted by other users) over the server's internet interface. The virtual card server will typically be configured to examine the card's receiving user information (to determine at least one destination address for that card), then transmit that virtual card over the server internet interface to the corresponding user computerized device identified by this receiving user information.

As an analogy, while the basic unit of social network communication over the “twitter/X” system is a called a “tweet” (originally a short text message, since extended), the basic unit of social network communication over the system described herein can be a “virtual card”, exemplified by the “news card” discussed above.

The virtual card server and user computerized devices are configured (usually by server software and suitable computerized device “apps”) so that wherein any of the user computerized devices receive (over that devices internet interface) a virtual card assigned to their user, that device's at least one processor further configured to process that particular virtual card and display at least some of this virtual card's news card information on that device's graphical user interface. This allows the user to see and interact with that particular virtual card.

On the transmitting side, at least some of the user computerized devices are configured to use their graphical user interface device (such as the touchscreen) to receive input data, and use their device processor and device network interface to generate a virtual card. The computerized device is configured to then transmit this virtual card to the virtual card server.

The machine-learning and optimization for specific areas of interest can be done on various levels. On one level, the virtual card server and LLM may be configured to analyze at least some of the virtual cards, and promote or demote distribution of certain virtual cards depending upon one or more weighing factors applied by the LLM. However, the system can also operate at a different news feed level.

At this news feed level, the virtual card server is configured to receive at least one news feed data stream reporting on a given domain of interest. This news feed can be of any type, including one or more user initiated feeds. In this embodiment, the machine intelligence engine is configured to store a history of this at least one news feed data stream, as well as a history of past exchanges between the various users, the (card) titles, the user interest flags, and the card payload data. The machine intelligence engine (LLM) is configured (trained) with this data, and as a result, the trained machine intelligence engine produces output to predict and influence what the virtual card server does with the input virtual cards. Note that this depends on the specifics of the news feed data stream.

More specifically, the as a result of this training, the virtual card server may then predict and influence (e.g. change) any of the receiving user distribution, priority, or machine-learning-enhanced presentation data of the virtual card before transmitting the virtual card over the server internet interface.

For example, say that the system is optimized for solid-state physics, and new development in high-temperature superconductors is reported over the news feed. The machine intelligence engine (LLM) may know from past history that certain users have discussed high-temperature conductors and others have not. The machine intelligence engine can communicate this information to the virtual card server. Depending upon its configuration, the virtual card server may then relay the high-temperature superconductor news to interested users, along with machine learning enhanced presentation data, such as formatting that particular news feed in larger bold fonts or otherwise enhancing the presentation. Further, the virtual card server can promote user-transmitted news cards that are either on topic, from users with a previous history of interest in the topic, or some combination of the two. The net result is that the invention produces a machine-learning-enhanced social network that is optimized for this specific area of interest (here, solid-state physics and room-temperature superconductors).

Financial transaction and trading embodiments:

As previously discussed, although the underlying invention can provide machine learning-enhanced social networks for many areas of interest, financial transactions and trading are of high interest to the general public. Thus, in some embodiments, the machine learning system (LLM) may be trained for high expertise in financial transactions and trading. Further, the social network system may be configured to human uses with such interests.

In this alternative embodiment, the invention may be used to provide a mobile or desktop-based platform for financial transactions and trading. More specifically, the present invention can be used to provide a method, apparatus and system for a user to avail of a framework to trigger his or her new or already existing social network to share and exchange information and news on financial trading instruments, make informed decisions and if necessary, trigger and effectuate trade of the securities of interest within the framework.

In some embodiments, the invention may be a computerized system and method for helping users select better or optimal choices based on his/her trading needs. In the modern world, choices are getting increasingly complicated and too often users do not have the knowledge or expertise to make the selections best suited for their needs, goals and financial objectives. Good examples are stocks, bonds mutual funds, insurance, housing, automobiles, consumer durables, medical equipment and healthcare facilities. Present invention seeks to create expertise synergies and sharing mechanism regarding financial instruments trading.

The present invention, is based, in part, on the insight that when people meet at a social event, usually after a short span of time, they start to talk about investments. Whereas they may not actually invest, they invariably talk about it. More often than not, such talk deals with discussions of particular stocks, market news, upside and downside discussions and perceived and or actual reasons behind the market price fluctuations. While investments are a topic of interest in face-to-face conversations, most people do not communicate about investment through mobile and/or web platforms, such as Facebook, Google Hangouts and WhatsApp etc. These are attributed to several reasons. First, financial news sharing and investing conversations are not welcome on these platforms. Second, for the purposes of the conversation, ice breaker from a legitimate and credible source is needed, rather than merely an unsubstantiated opinion. As an illustration, a stock group on WhatsApp usually dies in less than two months according to surveyed data. A number of persons, who are not primarily interested in financial transactions, but participate broadly in social network become mere sightseers and do not contribute to information gather and exchange. Current solutions, which are available, neither take a user's needs and preferences into account nor provide detailed analysis or recommendations solely for the purposes of financial news and transactions, they are general purpose platforms. Platforms like Facebook, LinkedIn, Twitter, Instagram, Snapchat are not focused on financial aspects and are mostly for impromptu and informal information exchange purposes. Closest comparison to financial social network under current solutions are WhatsApp and Stocktwits. WhatsApp suffers from the shortcomings that users do not prefer to share financial news, rather wish to be restricted to informal information sharing or fun. The news sharing and reading is not built into WhatsApp, but rather link based accesses require leaving the app. There is no notion of trending financial news, it is a general platform. Stocktwits on the other hand is not trusted network.

There is no policing, so anyone can say anything and legitimate source news is wanting. Users are not disciplined or focused on a common purpose to trade financial securities. Similar to WhatsApp, Stocktwits also does not have a crowdsourced and ordered newsfeed, only peoples' opinions are shared. None of these options take a user's needs fully into account or provide analysis and appropriate recommendations for stock and or securities trading.

The invention is further based, in part, on the insight that prior art social networks are highly lacking with regards to finance and investments. This is evident from the fact that none of the financial news website have a dedicated share button which can share the news on a network, where it is expected and welcome to be received. Most financial sites like seekingalpha.com, benzinga.com are using arbitrary share buttons, which are not used by everyone. One of the named websites attempts to share by general-purpose email, where the news may not be welcome and may be receiver specific as to its interest. So, there is a need for a social network where in users can discuss the financial news and share them freely, as the same is welcome expected and desired in this dedicated network.

The problem of “decision support through optional social network sharing and exchanging trending financial news for optimal selection of financial instruments by end user” solves the problem. While many solutions are feasible, the emphasis is on creating a solution which is simple, effective, user friendly and which would be applicable across many products and services with focus on financial trading of securities, mutual funds and bonds. This invention presents a solution for these issues and has the sought benefits.

### BRIEF DESCRIPTION OF THE DRAWINGS

FIG. 1A shows an overview of the system. Here at least one virtual card server (109) is configured to run the invention's AI enhanced social network.

FIG. 1B is an alternative embodiment of a system diagram illustrating the invention as more specifically applied to financial transactions and trading. It shows system where a social network is overlaid over the internet framework to be able to disseminate, share, and engage in public discourse over financial trading instruments. The figure also shows a trading platform, where various computers running internet are connected to trading system computer systems which in turn access the trading exchange.

FIG. 2 is one embodiment in an exemplary way of a mobile or desktop application with a screen display showing receipt of news cards from a plurality of senders when notification from the app is enabled on the cellphones.

FIG. 3 is one embodiment in an exemplary way of a mobile or desktop application screenshot obtained after pressing the “SEND” button on a financial news card in the transmit mode. It displays a whole list of persons obtained in one embodiment from a user's contact list, from where a list of persons can be chosen to whom the news card of interest is to be sent.

FIG. 4 is one embodiment in an exemplary way of a mobile or desktop screenshot of a chat participant receiver who has received two financial news cards over a course of about three hours and has chatted and is getting ready to send and initiate a news card of his/her own. The figure shows the social network overlaid over the internet being in play.

FIG. 5 is an exemplary embodiment of a mobile or desktop screenshot where the sender on the social network accesses chat news, where a news about carmaker TESLA is shared. The user converts the chat news as a financial news card, which is ready to be shared and sent. Stock symbol TSLA is displayed to be used as a link to access market parameters for the stock, all of which are provided by the app.

FIG. 6 is one embodiment of a mobile or desktop application screenshot of a recipient participant of the social network , here older news cards, along with the newly received TESLA news card is displayed. Also, it is overlaid with a new TESLA stock icon, showing the stock market parameters and further options to be able to read more or effectuate a trade.

FIG. 7 is one embodiment of a screenshot of a mobile or desktop application of a sender where user has chosen the “SEND” button from the news card, it displays the user to whom the news card would be sent, further a scheme is provided to name additional stocks with a prepend of the “$” sign and to be able to share additional research (associate news to stock(s)) and news material for a new related or unrelated stock. It also shows that once the type window is chosen, a keyword to be able to type.

FIG. 8 is an exemplary embodiment of a screenshot of a mobile or desktop showing a chat session, with two juxtaposed windows or screen split, with one showing a list of all possible users from a contact list and an active chat session with a named user, where the news cards are sent, along with communication from both sides. This application is built over the social network dedicated to the financial news exchange and discussions.

FIG. 9 is an exemplary embodiment of a screenshot of a mobile or desktop the entire flow executed by the app or framework, starting from news obtained from the relevant financial sites, invoking the app through sharing or explicit call, showing the “SEND” screen, with relevant news cards, the receiver's corresponding screen, with the LYFT news card received, various options for the user and the user deciding to explore the stock LYFT for forming his/her own opinion, doing further research or to be further sender or sharer of the news on the social network.

FIG. 10 is an exemplary embodiment of a screenshot of a mobile or desktop showing access of the financial news, receipt of financial news cards, and the ability to share the same on a variety of apps, including the one that has been proposed.

FIG. 11 is an exemplary embodiment of a screenshot of a mobile or desktop showing the send menu for the news card to be disseminated with all or individualized persons on the contact list.

FIG. 12 is an exemplary embodiment of a screenshot of a mobile or desktop showing a plurality of news cards, with appropriate menus to be able to send and share them with a plurality of persons in the contact list. Among four possibilities, the trending prong is chosen, with corresponding news cards shown.

FIG. 13 is an exemplary embodiment of a screenshot of a mobile or desktop showing a plurality of news cards, with appropriate menus to be able to send and share them with a plurality of persons in the contact list. Among four possibilities, the “most read” prong is chosen, with corresponding news cards shown.

FIG. 14 is an exemplary embodiment of a screenshot of a mobile or desktop showing a “WATCHLIST” screen derived from the home screen. User can get all relevant updates of stocks placed on the watch list.

FIG. 15 is an exemplary embodiment of a screenshot of a mobile or desktop showing the derived screen when “SHARE” button is chosen from the home screen. User gets ability to choose a single or group chat to disseminate financial news cards.

FIG. 16 is an exemplary embodiment of a screenshot of a mobile or desktop showing the derived screen when “ANALYTICS” button is chosen from the home screen. User gets ability to see information on a number of stocks chosen from being trending, preset, or market most active, among others. Click on histograms takes to all relevant financial news cards.

FIG. 17 is an exemplary embodiment of a screenshot of a mobile or desktop showing “MARKET MOVERS” screenshot, superimposed over the news card screen. Market parameters are displayed for various indices, along with top gainers and losers with pointers to trade through stock symbols.

FIG. 18 is an exemplary embodiment of a screenshot of a mobile or desktop showing a plurality of news cards, with appropriate menus to be able to send and share them with a plurality of persons in the contact list. Among four possibilities, the bookmark prong is chosen, with corresponding news cards shown.

FIG. 19 is an exemplary embodiment of a screenshot of a mobile or desktop showing a plurality of news cards, with appropriate menus to be able to send and share them with a plurality of persons in the contact list. Among four possibilities, the “latest” prong is chosen, with corresponding news cards shown.

FIG. 20 is an exemplary embodiment of a screenshot of a mobile device or desktop showing a news card employing an AI+ summary of the news.

### DETAILED DESCRIPTION OF THE INVENTION

In the following description specific details are set forth describing certain embodiments. It will be apparent, however, to one skilled in the art, that the disclosed embodiments may be practiced without some of these entire specific details. The specific embodiments presented are meant to be illustrative, but not limiting. One skilled in the art may realize other material that, although not specifically described herein, is within the scope and spirit of this disclosure. For purposes of this disclosure, the system (sometimes called a “framework) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the system may be a hardware device of size, shape, performance, functionality, and price. In another embodiment, it may comprise of software components capable of being loaded to run on a hardware device. The framework system may include random access memory (RAM), one or more processing resources such as a central processing unit (CPU) or hardware or software control logic, read only memory (ROM), and/or other types of nonvolatile memory. Additional components may include one or more disk drives, one or more network ports for communicating with external devices as well as various input and output (I/O) devices, such as a keyboard, a mouse, and a video display. The framework system may also include one or more buses operable to transmit communications between the various hardware components. The framework system may be dedicated system of hardware and software. In another embodiment, it may constitute transferable software code loadable and runnable on a general-purpose computer system.

Software, in accordance with the present disclosure, such as program code and/or data, may be stored on one or more machine readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

This is an information sharing system and method to help a user decide which option/choice is best suited for his/her purposes, from a multitude of such options or choices to buy financial instruments which may be available. The analysis of each option to buy is based on information received and transmitted to a plurality of social network participants who have earlier indicated their consent to send and receive financial news information. The tool is dynamic in nature. More options as well as user-inputs can be added to the tool to make it more sophisticated over time. In this embodiment, the system is used for disseminating, receiving, consolidating financial instruments news, assimilating it and then if appropriate and so deemed, invoking the various trading servers to be able to effectuate the trades. In another embodiment, it may be used for disseminating, receiving, sending and sharing of regular insurance, choice of mutual funds, housing, automobiles, consumer durables, medical equipment and healthcare facilities. The benefits provided, in one embodiment include ability to send financial news card to ones'social network in chat or otherwise and title in notifications through web and mobile platforms with an underlying link to trading sites. In another embodiment, the system may provide a connection of financial news websites to discussion with acquaintances, finding trending news and using it for stock trading. The system therefore provides for social networks optimized for financial news with an optional ability to trade stocks. The always connected present world needs community of investors chatting with each other on mobile and desktop platforms. In the community of investment, some people talk actively about investment and some are just sightseers engaged in listening only. A social network is needed to address these two categories of persons. This invention connects the active investors as well as provides most trending, latest, most read or bookmarked news to sightseers. The system may also enable a casual observer to turn into an active trader, based on the information exchanged, studied and assimilated.

In one embodiment, a new data structure driven windowlet screen shot is which serves as the unit of information shared between users. A “news card” is an entity comprising of a display financial news title; ability to read the news details after clicking the news title; display of news source website information; associate stocks with its current market value, market value at the time of financial news card was sent and daily change; ability to quick connect with stock specific trending, latest, most read news; ability to add or remove stocks to and from watch list; provide quick ability of trading stock and financial instrument with a launch to financial applications; ability to send and share the financial news card with social network; ability to display count/order of news for “trending news” and “most read news” and time stamp for the “latest news”; ability to bookmark the news card; ability to provide news card notification with news title to social network with the username; ability to associate or remove stocks to news card and add or update or delete comments to news card.

This system provides workflows of connecting the financial news sites to news sharing with friends in chat and title in notifications through desktop or mobile platforms. In other words, a dedicated social network is solely for financial news and trading. In some embodiment, the system may provide an ability to connect the stocks during sharing, launch a stock trading website to convert news to stock buying, ability to trend the news based on the sharing, suited for passive reader and ability to highlight most read news, latest news, and bookmarked news, also suited for passive reader analysis.

In one embodiment, this invention describes a method, apparatus and system to bridge financial news to trading website. The publication of financial news on different websites impacts the market and the stock value. Users who may be investors read this news and analyze the current stock price, deduce the future price most often discussing with their network participants. There is social network available like LinkedIn for career, Facebook for friends and WhatsApp for communications. Similarly, a dedicated network where in people can talk to their friends for the investment discussions which sources and is based on financial news from the appropriate websites is. This has ability to exchange peer to peer (or peer to expert even) financial news cards on mobile and desktop with associated stocks and comments. Whereas the news sharing may be common, a peer-to-peer financial news sharing on hitherto unavailable social network platform is a distinction for a financial news sharing.

The system can be used for various products and services as well as implemented using different technologies. In one embodiment the system can be focused on financial news sharing. In another embodiment the system can be used on stocks related to a particular segment. In yet another embodiment, it can be used for right and properly priced sector selection and then for particular financial instruments.

In one embodiment, the invention is implemented through a desktop or mobile based app likely to be named “Opiniontrade” which provides for exchange and dissemination, assimilation of financial news cards with functions of sending title of the news in notifications to another user;

sending title of the news in notifications to multiple users with selection through check boxes; sending title of the news in the notification groups; showing title of news in notifications; showing associated stocks; ability to read the news from the title of news; provision of stock button showing the details and ability to launch other apps; comments of user, add the new stock name with $name of stock; ability to send mobile notification from web to mobile with above functionalities.

In one embodiment, this virtual card based server social network system can be configured to use financial news cards as entity which comprise, but are not limited to, displaying financial news title, ability to read the news details after clicking the news title, display news source website information, associated stocks with its current market value, market value at the time of financial news card was sent and daily change; ability to quickly connect with stock specific trending, latest, most read financial news is provided; ability to add or remove stocks to or from watchlist. The financial news card also provides quick ability of trading stock or other financial instrument with a launch to financial application; ability to create an entity as a financial news card and send and share the financial news card with social network; ability to display count/order of news for trending news and most read news and time stamp for the latest news based on machine learning algorithms; ability to bookmark the news card for future reference; ability to provide news card notification with news title for this social network for investment with the username; ability to associate or remove stocks to news cards; and add or update or delete comments to news card.

In one embodiment, faster rendering of screen is achieved as the system can be optimized by modifying the native modules to load individual listener for every stack of news screen rendering, thus increasing the performance of application by 4 times. Performance enhancement is achieved by loading of screen behavior as the device processors can introduce a custom-built loading mechanism where in individual text will be shown as loading, resulting in end user feeling with better performance.

In another embodiment, faster chat loading is achieved through asynchronous call to backend system provides faster loading of chat summary. Details are fetched on specific chat loading. This has been achieved based on RAM format enablement where in memory is allocated in an advanced specific manner. In one embodiment, search algorithms are designed to retrieve information from local system cache before it goes to server value retrieval, resulting in most cases search available at faster speed. In stock association to news, stock association to news is done at server level, resulting in faster association and quick retrieval of news and stock association. In another embodiment for watch list news display, stocks associated to watch list shows news related to watch list stocks only. Performance is optimized by having limited information at mobile app while association check at server level with quick information retrieval. In one embodiment, asynchronous calls are used all around to display the needful data only for faster loading.

In one embodiment, application provides machine learning and algorithm-based ratings for investment news so that the end user can get “trending,” “most read” and “latest” financial news and stocks to make decision. Ordering of financial news are achieved by populating the data models from wide user base and subscriber base interactions for a specific financial news. This results in one end user quickly accessing the information which got rated and or selected by other users and subscribers of system. In one embodiment, the system will be able to identify the most viral financial news of the day or over several days, which is of interest to user(s) who are notified. In this embodiment, system will be able to find hot and viral news quickly through trending counts. User(s) who have chosen to be notified shall be notified promptly.

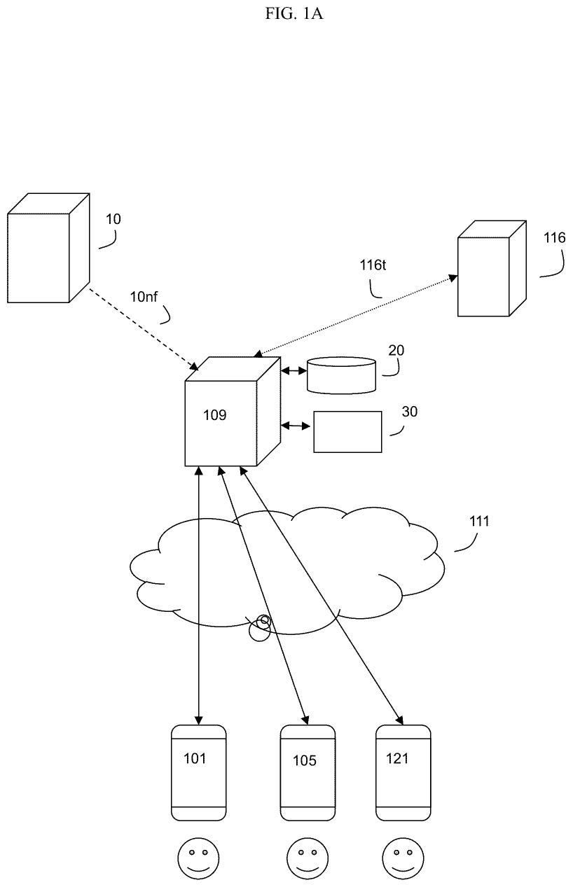

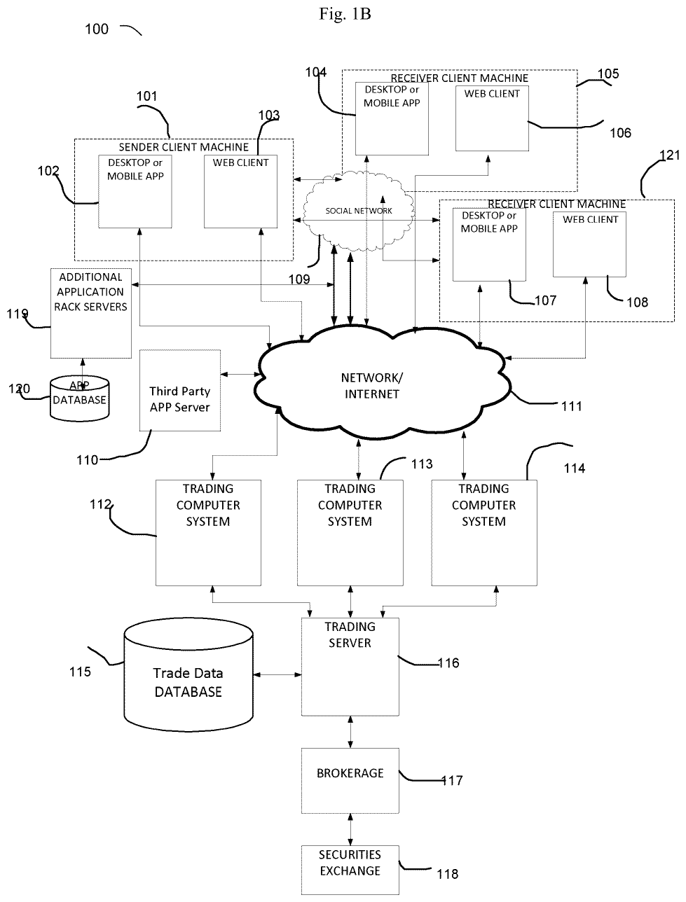

FIG. 1A shows the highest-level overview of the system. At least one virtual card server (109) is configured to run the invention's AI-enhanced social network. This virtual card server (109), sometimes also termed a “social network”, comprises at least one server processor, server memory (20), a server internet interface connecting to the internet (111), and a machine intelligence engine (30). The server is configured to communicate with a plurality of user computerized devices (101, 105, 121), such as smartphones or similar devices. These user computerized devices will typically comprise at least one device processor, device internet interface, and a graphical user interface (such as a touchscreen). The interchange of virtual cards between the user computerized devices (101, 205, 121) and the virtual card server (109) is shown by the three solid double-headed arrows. Here virtual card server (109) is also configured to receive at least one news feed (10nf), here from a news feed server (10). This is shown by the dashed arrow. In some embodiments, the virtual card server (109) can also be configured to communicate with other servers, such as trading servers (116), as shown by the dotted double-headed arrow (116t).

Thus, in some embodiments, the invention may be a computerized system comprising a virtual card server (109). This virtual card server comprises at least one server processor, server memory (20), server internet interface (111), and a machine intelligence engine (30). This machine intelligence engine is trained for a domain of interest. As previously discussed, although finance and stock trading are used as examples, many other domains of interest can also be used.

Although various types of machine intelligence engines may be used, in a preferred embodiment, the machine intelligence engine (30) may comprise a large language model (LLM) configured for at least a general-purpose AI. This LLM will typically comprise a plurality of multiple neural network layers. These multiple neural network layers and the LLM are trained for this domain of interest.

Examples of suitable LLM include the GPT models, such as GPT-3.5 and GPT-4 produced by OpenAI. Various open source LLM that may be used for this machine intelligence engine include LLaMA 2, BERT, Facon 180B, OPT-175B, XGen-7B, GPT-NeoX, and Vicuna 13-B. Examples of suitable LLM hardware include Graphics Processing Units (GPU) produced by Nvidia and other companies.

The virtual card server is configured to communicate with a plurality of user computerized devices, such as smartphones (101, 105, 121). Each computerized device will comprise at least one device processor, device internet interface (such as a suitable Wi-Fi or cellular connection to the internet), and graphical user interface. This graphical user interface may often be a touchscreen.

As previously discussed, according to the invention, the virtual card server is configured to support a social network that uses virtual cards as the fundamental unit of communication. That is, the invention's social network will exchange data structures that can be organized and represented as virtual cards. The underlying data itself will, of course, be transmitted by data packets formatted according to standard internet protocols.

In a preferred embodiment, these virtual cards may comprise news card information. This news card information in turn is typically comprises address information, such as at least one transmitting user identification, and at least one receiving user distribution. This address information informs the virtual card server which user originated the news card, and also identifies the user's preferred news card distribution list. The news card information will typically further comprise, a title (e.g. the news card's display title) priority (relative importance of that particular card, which can be used by the server to control card distribution, as well as by the user computerized device to control the order the card appears on the graphical user interface). The news card can also comprise card payload data (e.g. additional text, graphics, or other card information intended to be displayed), machine-learning-enhanced presentation data (commands generated by the machine learning system that may influence how the card is handled by the server or displayed by the user computerized device. Other news card information can include one or more user interest flags (e.g. user likes, user reposting information), and at least one user command. This user command is often reserved for use by external servers, such as trading server (116). Thus, if a user wishes to the invention's virtual card system to transmit a command to purchase stocks, this may be mediated by a user command field on a user-transmitted virtual card that is transmitted (116) to the trading server (116).

As previously discussed, the virtual card server (109) is configured to exchange virtual cards by receiving virtual cards over its server internet interface (111). The server processor is configured to examine the card's receiving user information (e.g. user information identifying any of 101, 105, 121), and use this receiving user information as a destination address to in turn transmit (e.g. relay) that virtual card over the server internet interface (111) to the corresponding user computerized device (e.g. the device previously identified by the receiving user information). So here, the system is acting as a somewhat standard social network, relaying user posts from user to user according to various addressing protocols.

On the user-computerized device (receiving end), when any of the user-computerized devices (101, 105, 121) receive a virtual card assigned to their user over the device internet interface (111), that devices' at least one device processor is configured to process the virtual card (e.g. decode the various data fields transmitted by that virtual card), and display at least some of that virtual card's news card information on that device's graphical user interface. That is, show the social network posting on the screen.

To transmit social network postings, user commands, and also communicate with system, at least some of the user computerized devices (101, 105, 121) are configured to use their graphical user interface device to receive input data (e.g. user GUI entered data) and use their device processor and device network interface (111) to generate one or more virtual cards and transmit these virtual cards to the virtual card server.

What helps distinguish the system from prior art social networks is, in part, a function of how the system uses machine intelligence to control how the system works as a function of varying news topics and user interests and input.

In a preferred embodiment, the virtual card server (109) is also configured to receive at least one news feed data stream (10nf from news server 10). This news feed reports news relevant to one or more domains of interest;

A key aspect of the invention is that the machine intelligence engine (30) is configured to analyze this news stream and make social network decisions based on the news stream data. To do this the machine intelligence engine is trained on a history of this at least one news feed data stream. The machine intelligence engine is also trained on a history of past exchanges between the various users, various virtual card titles, various virtual card user interest flags, and various virtual card payload data.

The machine intelligence engine is trained on this data, to produce outputs that use past data to predict and influence how the system will handle presently incoming virtual cards. In particular, the machine intelligence engine (30) and virtual card server (109) may now not just pass through virtual cards as-is, but instead alter any of the any of the receiving user distribution, priority, or machine-learning-enhanced presentation data of the incoming virtual cards before transmitting the virtual card over the server internet interface.

For example, consider a news stream containing breaking news regarding a publicly traded company, such as Tesla. The machine intelligence engine may know from training data that such topics are of high interest, and also know that certain users, in the past, have exchanged higher than average numbers of virtual cards on this topic. Based on this information, the virtual card server may then flag this news item as being of high priority, flag that the user's graphical user interface should display it at high priority, and also preferentially transmit news cards from users that have either a higher historical interest in the stock, are mentioning the stock in their news card's title or payload, or both. Here, using “both” would be more likely to transmit social network messages from recognized or self-appointed Tesla “gurus” who are also discussing the topic.

Further details:

In some embodiments, the graphical user interface is an AI-enhanced graphical user interface.

That is, the user-computerized device's processor is configured to recognize certain machine-learning-enhanced presentation data transmitted by the virtual card server for any given virtual card. The user computerized device then uses this machine-learning-enhanced presentation data to alter the display of the virtual card (news card) on that user's graphical user interface.

Put alternatively, the user computerized device is further configured to display at least some of the virtual card's news card information on its graphical user interface according to any of the receiving user distribution, priority, or machine-learning-enhanced presentation data.

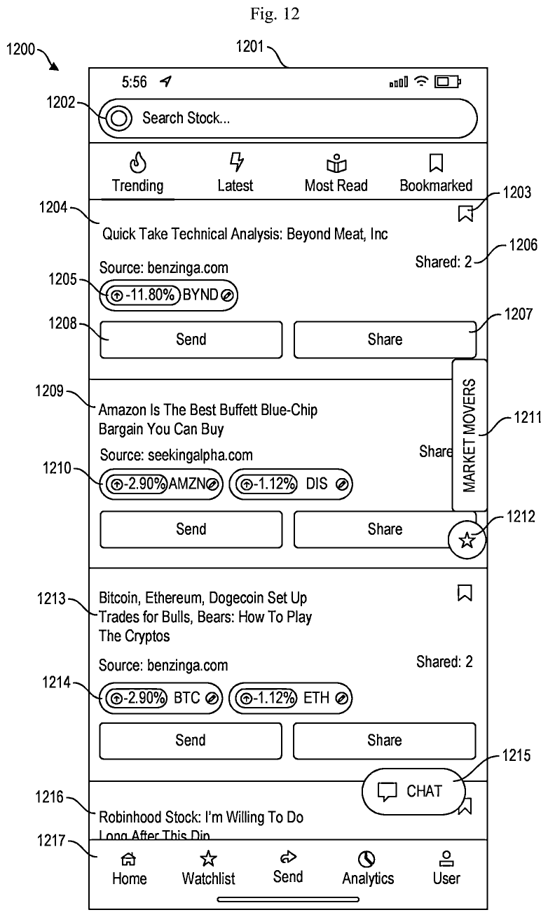

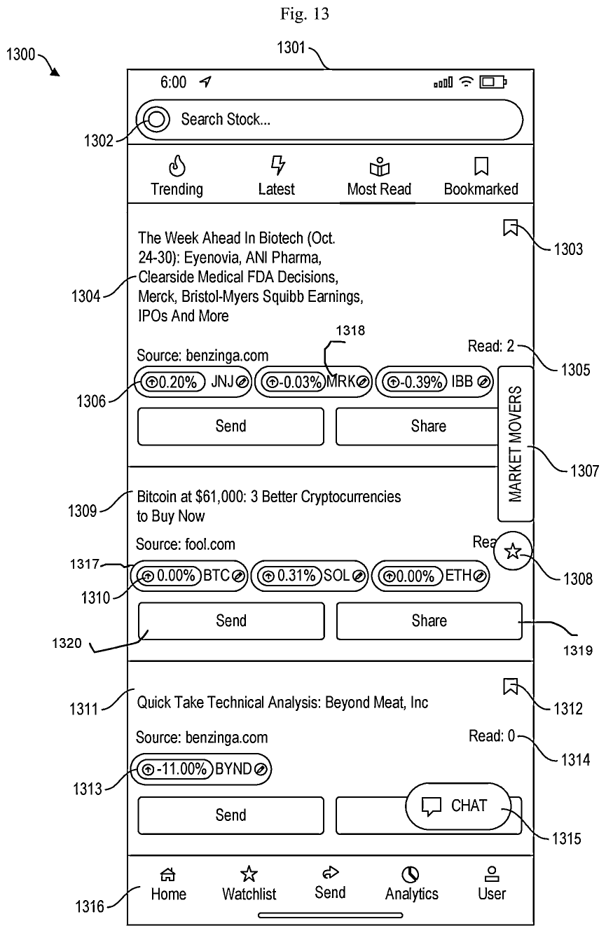

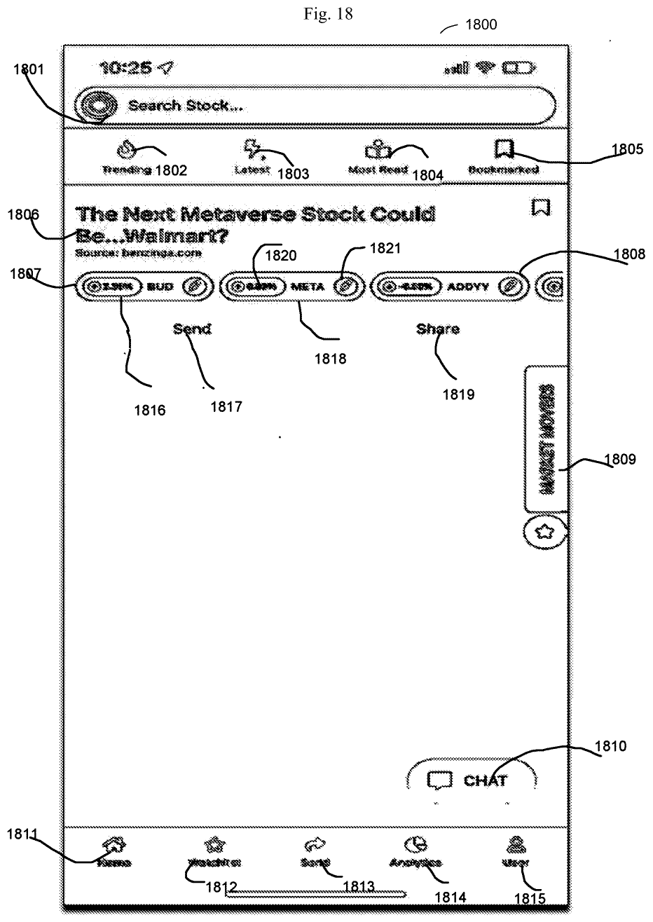

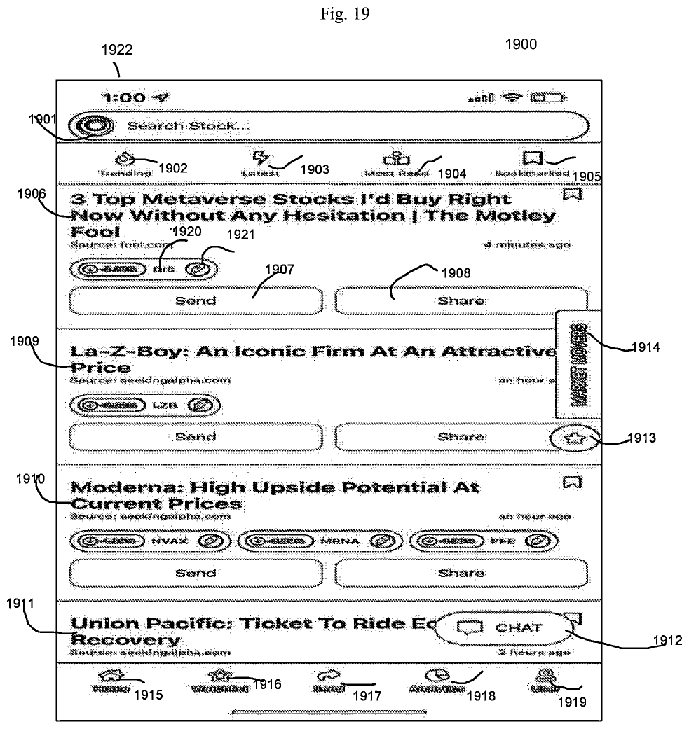

Examples of such AI-enhanced graphical user interfaces may be seen in FIG. 12, FIG. 13, FIG. 18, FIG. 19, and elsewhere. In these examples, the machine intelligence engine (30) may be configured to extract certain items of interest from the news feed (10nf), and flag these items for preferential display on the GUI of the user computerized device.

To elaborate on this, in these embodiments, the machine intelligence engine (30) may be further configured by neural network training to determine if certain types of news feed data stream items (10nf) correlate, for at least certain users, with higher amounts of user interest flags as being news items of potential user interest. In these embodiments, the virtual card server (109) maybe configured to transmit at least some of the news feed data stream (10nf) to the machine intelligence engine (30). This machine intelligence engine uses at least some of the news feed data stream (10nf) to determine if there is a correlation with certain previously determined news items of potential user interest.

Here, the virtual card server is further configured to transmit such news items of potential user interest to the appropriate set of user computerized devices for display on their AI-enhanced graphical user interface(s).

Using the invention's social network to perform real-world tasks:

As previously discussed, in some embodiments, the system may be configured to implement additional commands outside of the social network. These additional commands may include control of various remote devices, receipt of data from various remote sensors, and also purchasing or selling various virtual or real items, such as various products and services. These additional commands can include commands to execute various types of financial transactions.

In some embodiments, the virtual card server (109) may be configured to examine an incoming virtual card for at least one user command. In such situations, at least one of these user commands are not null and directed to a third-party server system, (such as financial transaction server 116), the virtual card server can be configured to transmit this at least one user command to this third-party server system (116).

As will be discussed in more detail shortly, in some embodiments, these commands can comprise financial instrument transaction commands (116t), and this third-party system (116) may be configured to execute these transactions. In such embodiments, the machine intelligence engine (30) may be trained for a domain of interest that comprises any of economics, business, and stock investing. In such cases, the virtual card server (109) may be configured as both a financial investment framework system and a social network.

About Training Methods:

In some embodiments, configuring the virtual card server (30) for a given domain of interest is done by training the machine intelligence engine using a history of at least one news feed data stream, as well as the history of past exchanges between various users, and (with respect to the virtual chards they are exchanging) the news card titles, user interest flags, and payload data. In a preferred embodiment, the training is designed to configures the machine intelligence engine to predict and influence any of the receiving user distribution, priority, or machine-learning-enhanced presentation data on various received virtual cards, thus producing modified received virtual cards. After this modification, the virtual card server will subsequently transmit these modified received virtual cards to the relevant user computerized devices.

Specific Examples:

FIG. 1B, 100 shows an alternate embodiment of the invention that is more focused on finance and trading. Here, sender and receiver clients or users 101 105 121 are available on their respective client machines (smartphones, laptop computers, desktop computers, tablet computers, smart watches and so on) running a program 102 104 107 as well as a web client 103 108 106. This invention proposes a dedicated social network (implemented by virtual card server 109) for financial news card exchanges. Each of the sender and receiver user 101 105 121 communicates with other users 101 105 121 over the virtual card server implemented social network 109 for finances. Besides the virtual card server implemented social network 109, each of the users be they a sender or receiver 101 105 121 is in direct contact with an internet network 111. The new virtual card server social network 109 communicates via the internet network 111. The virtual card server can also communicate, via internet network 111 to a plurality of third-party application servers 110. These can be, for example, one or more trading computer systems such as 112 113 114 with their corresponding memory and processor. Each of the trading computer systems 112 113 114 may link a common or individual trading server 116, with its dedicated trade database 115. The trading server 116 may be connected to a plurality of brokerages 117, which have ability to communicate with a securities exchange 118 for trading of financial instruments. Additional rack servers 119 and corresponding database 120 may also be made accessible to users.

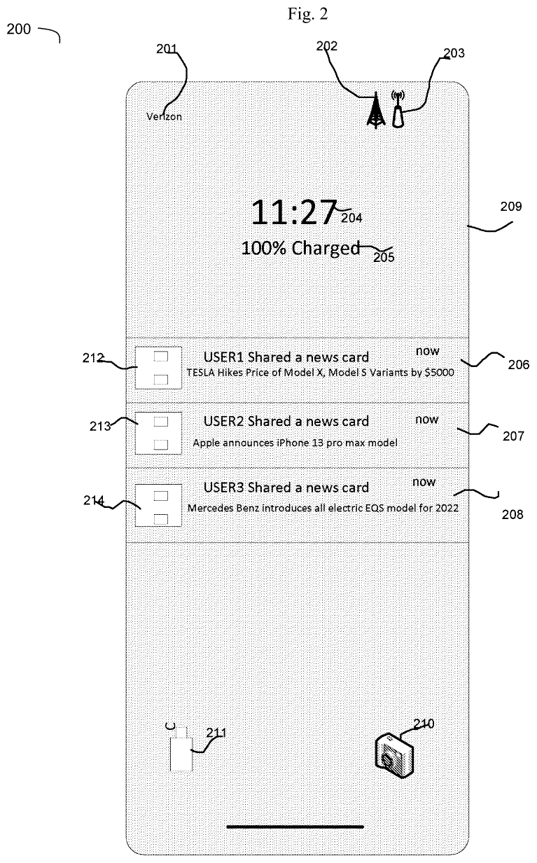

FIG. 2 200 illustrates as one embodiment of a mobile or desktop application screen shot 209 showing a service provider 201, availability of Wi-Fi 203 and wireless connection 202. The screen shot 209 shows receipt of a plurality of financial news cards 206 207 208 received from other users. The screen shot 209 shows current time 204 and amount of charge 205 available with the device 209. As a standard screen shot 209, the device provides a button to light a torch 211 and enable a camera 210. When enabled, notification on receipt of news cards and messages is provided 212 213 214.

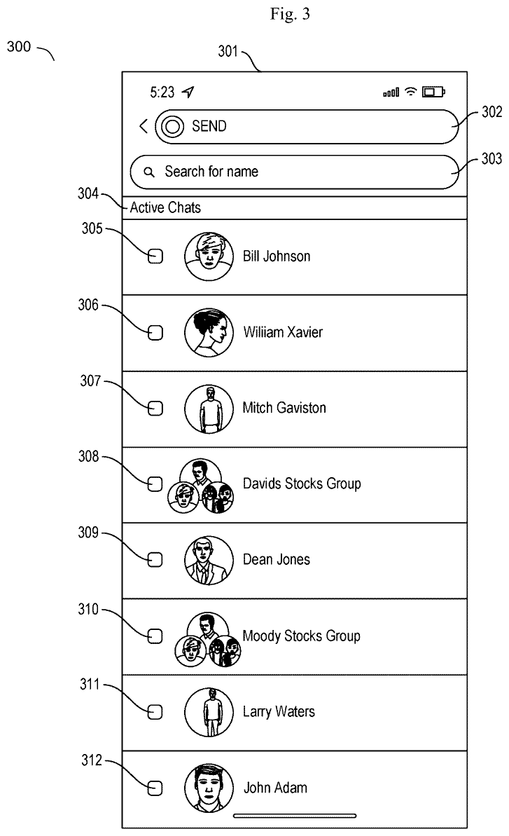

FIG. 3 300 is an exemplary illustration of a mobile or desktop application screen shot 301 showing that the sender user has chosen the “SEND” button 302 from a financial news card that then triggers listing of all possible recipients 305 306 307 308 309 310 311 312, with a list obtained from the user's contact list in one embodiment. User is provided a button to tick 305-312 to enable transmission to a plurality of recipients on the list 305-312. A type space window is provided to search users 303 from the list for speedy selection from an active chat 304. Also, the “SEND” function window is triggered based on the choice by the user 302.

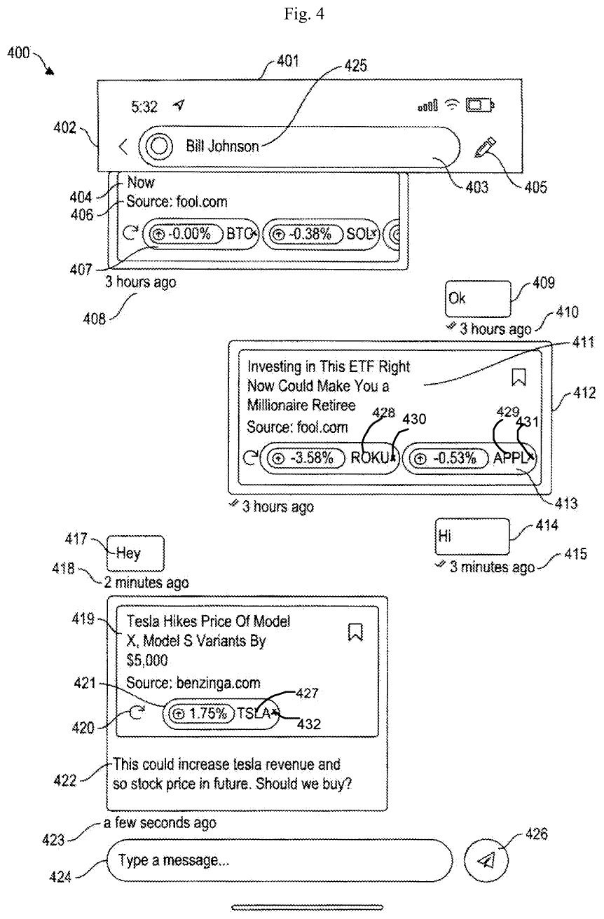

FIG. 4 400 is an exemplary illustration, in one embodiment, of a mobile or desktop application screen shot 401 for a particular named user 425. The left side is the initiator's half of the communication 417 418 423, while the right is the receiver side of the communication 414 415 412. A news card is shown received earlier 404 406 407 408 and a news card is also shown as recently received 419 421 420 422 423. A financial news card has a title 419 411, source of the news 406 and a list scannable of stocks 407 413 421 and other financial instruments including stocks 407 413 421 showing change in value and stock symbol. The appropriate buttons 420 within financial news card provide availability to research the stock 421 407, see its current market parameters. Part of the financial card receipt also relates the time when it was received 408. Besides the financial news cards, regular greetings and communication 422 is also shown on both sides 417 409 414. Each financial card gives ability to pass comments and opinions through typing 422 424. Comments of the sender are also displayed on receipt on receiver's chat transcript 422. Each stock symbol 427 428 429 shown provides a link to the trading site 421 and access to trading platform 421. Mechanism is provided to see sender details 405. Option to trade stock at financial application is provided 430 431 432.

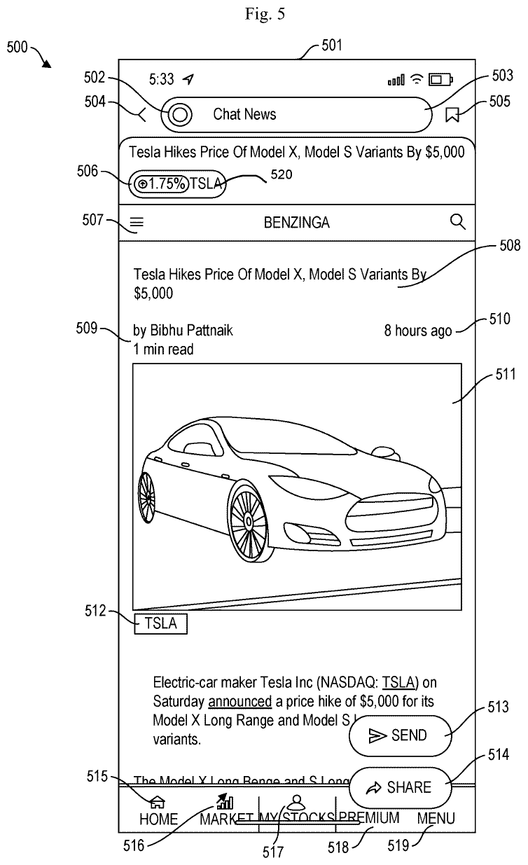

FIG. 5 500 is an exemplary illustration, in one embodiment, of a mobile or desktop application screen shot 501 showing initiation and acquisition of a financial news through chat 502 504. Within the application, user enables chat news 502 and by accessing BENZINGA website 507, as an exemplary illustration, accesses news about TESLA 506 508 509 510 and one of their models. The news gives access to TSLA stock 506 512, its present value 506, the time it will take to read the news 509, time it was posted 510, associated pictures. 511 In a superimposed way, “SHARE” 514 and “SEND” 513 buttons are shown to access to screen shot embodiments already described, particularly the screen shot associated with “SEND” 513 button. The app also gives linked access to app's home page 515, market 516, user's stocks 517, bonus or additional news through premium 518, and a MENU button to list all possible choices available to the user 519. There is provision 506 for stock details with a popup to find “trending,” “latest,” “most read news” and option to add or remove to and from watch list. There is also support to be able to trade stock at financial application 520 and get latest, trending and most read financial news for TSLA and add or remove stocks to and from watch list. User can also swipe right or left to read next news.

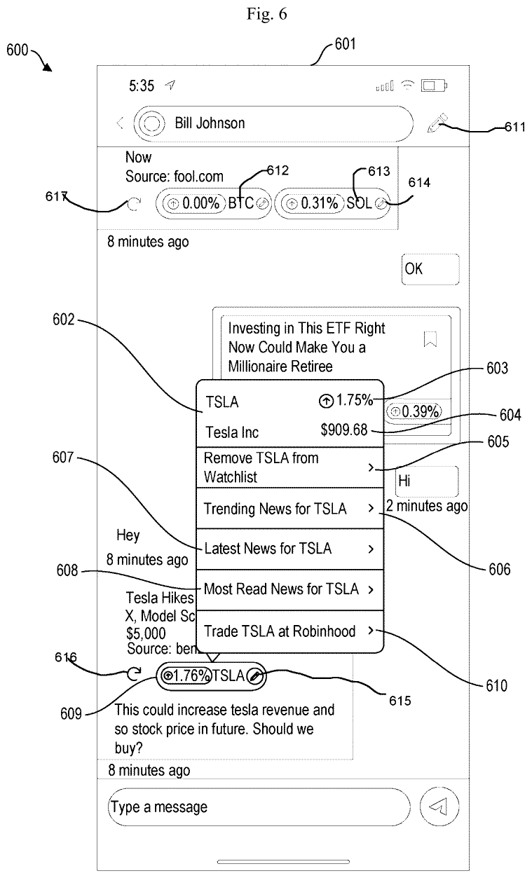

FIG. 6 600 is an exemplary illustration, in one embodiment, of a mobile or desktop application screen shot 601 showing a receiver's end of the app usage. The receiver receives a normal greeting, a financial news card received some time ago, and as an exemplary embodiment, the TESLA news card just received 609, after being extracted from a financial site and sent over by another user on the social network. User has pressed the TESLA stock further information link 609, so information on the stock is displayed on a superimposed window within the screen shot 602 607 608 603 604 605 606 610. The superimposed window gives additional options to user to add or remove TSLA stock to and from watch list 605, access trending news on TESLA 606, most read news (or latest news, trending or bookmarked) about TESLA 607 608 and an option to trade TESLA at a financial application 610 615. A specific icon is provided for it also 614. The financial news card on TESLA is also shown as received 609. Option is provided to access and get linked information for the stock at issue as well as all related stocks say within the same sector 609. A message type window is provided for user to further interact if needed, prior to initiating a trade, if that is desired. This figure is specifically focused on description of the superimposed window showing plethora of information available on any particular stock merely by pressing a button within the window. Ability to research current value of stock is provided 616 617.

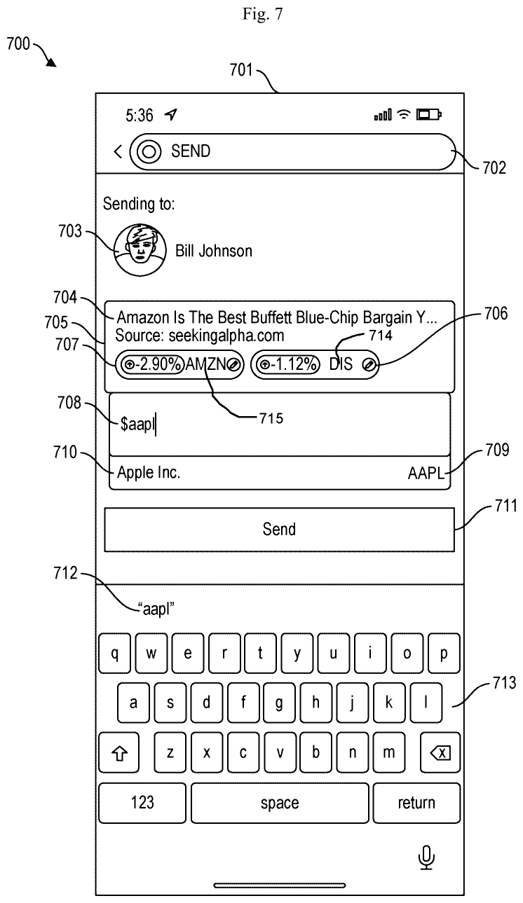

FIG. 7 700 is an exemplary illustration, in one embodiment, of a mobile or desktop application screen shot 701 showing a sender's end of the app usage 703. The sender chooses a receiver 703 from the available contact list as described on a previous window. The particular news card is synthesized in an exemplary way for AMZN related news 704 705 707 706. The news card has a title of news 704, pointer to AMZN stock 707 and other related stocks 706. Option is provided to type “$” and append any stock symbol 708 through invocation of a key board 712. By adding the new stock and sending it, 708 receiver can access all of the information associated with the “AAPL” stock in an exemplary way 708 710. An option is provided to input stock symbol and comments through voice also.

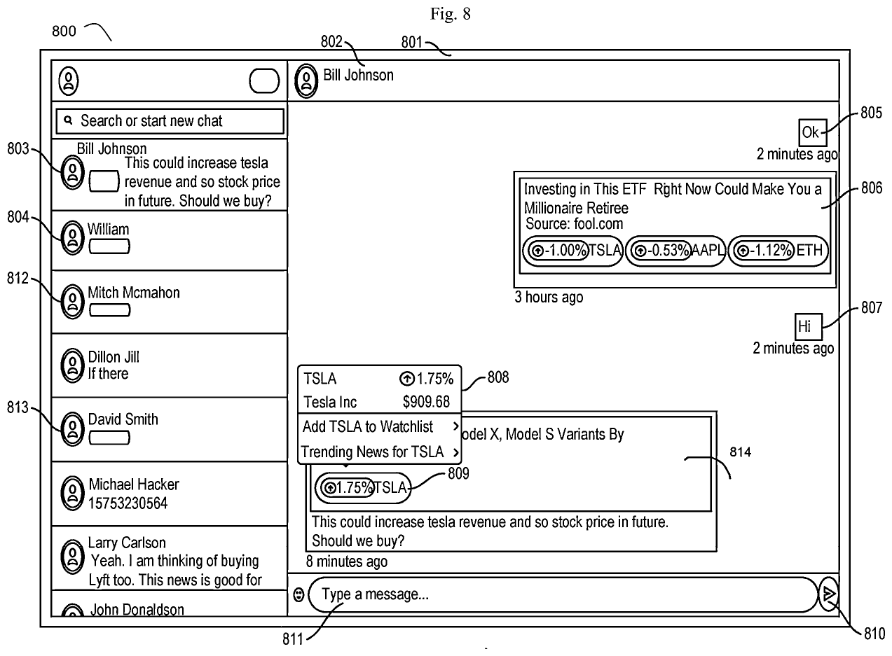

FIG. 8 800 is an exemplary illustration, in one embodiment, of a mobile or desktop application screen shot 801 showing a sender's end of the app usage 802 803. The single screen shot is split from the sender's view point of choosing a particular user from a list of possible receivers 803 804 812 813. The second juxtaposed screen is for the chosen receiver 802, where the entire finance related chat session is shown 805 806 807 808 809 811. It includes informal communication 805 807, send and received news cards 806 814, windows to add comments 811 and send it further down the contact list all information related to financial news cards. The received comments are also shown. If one is chosen 811 810, a superimposed window on the chosen stock also appears 808. The figure is illustrative of the use of the app from a sender's standpoint.

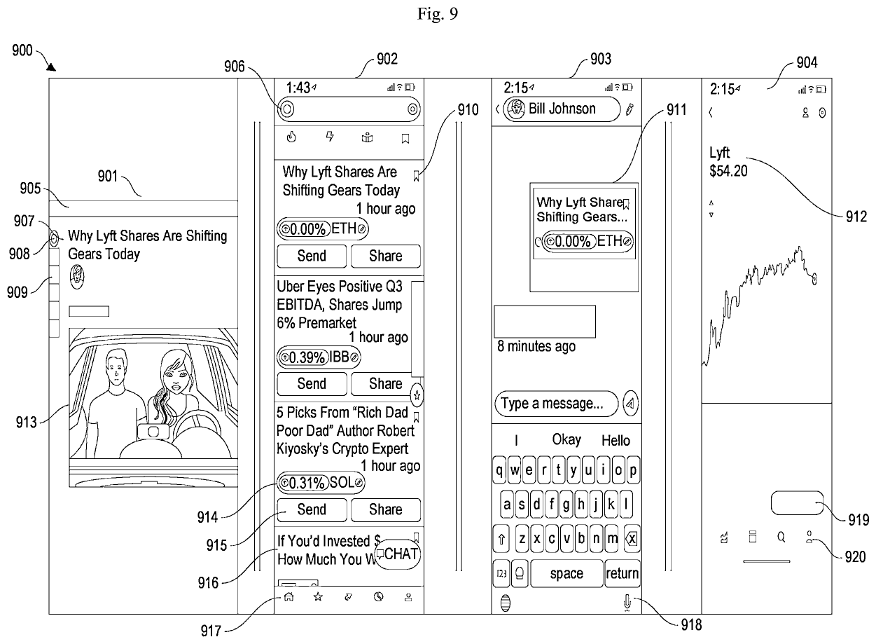

FIG. 9 900 is an exemplary illustration, in one embodiment, of a mobile or desktop application flow 901 902 903 904, which is exemplified with four windows which are juxtaposed side by side 901 902 903 904. The first window shows the chat news extracted or sent from accessing financial websites, with LYFT being the exemplary stock 901. Through “SHARE or SEND, the mobile or desktop application is invoked to be able to compose financial news cards 902. A plurality of financial news cards is formed, each of which gives a share and send mechanism to chosen users from the contact list. 910 914 915 916 917. Ability to book mark and invoke a chat session is provided. 910. From this screen, the choice of a user invokes the third window for a named user. 903 The sent news cards are shown as received, window is provided to type a message, and a keyboard invoked to be able to access and add new stock or other financial instrument symbols 911 918. The user then invokes the stock details through trading website of choice to obtain a window of information related to the stock. 904 912 919 920. The first two are windows from the sender's perspective 901 902 and the last two in the flow are from a receiver's perspective 903 904. There is a mechanism to push the news from external website to intended application. This is the way financial news is crowd sourced. 908.

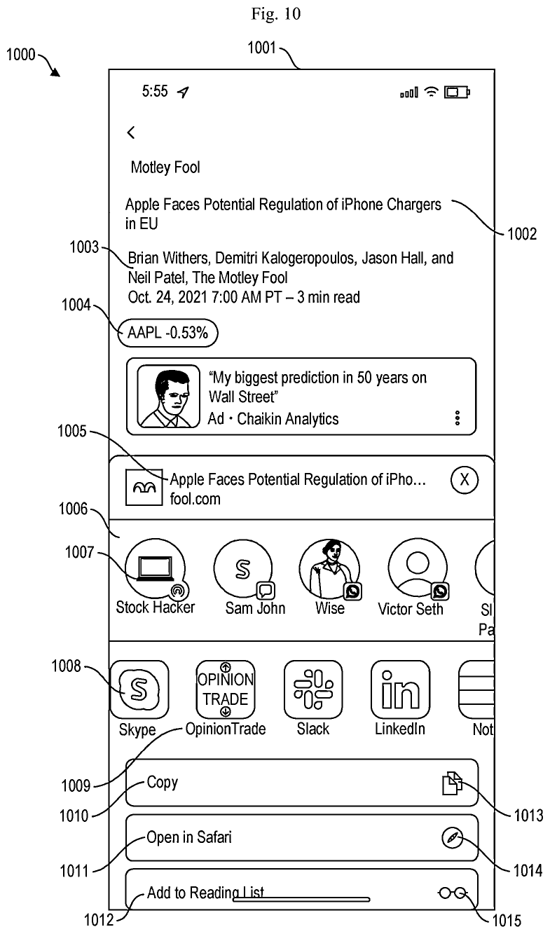

FIG. 10 1000 is an exemplary illustration, in one embodiment, of a mobile or desktop application screenshot 1001. A standard desktop application or mobile screen shot is shown, with financial news 1005 displayed from the financial news sites 1001 1002 1003 1004. As a top-level option, all users list is displayed with the availability shown whether on phone 1006, WhatsApp, another chat etc. 1007. Also, a series of applications are shown to be displayed which includes the newly app likely to be named “OpinionTrade.” 1008. Other applications like skype, slack, LinkedIn are displayed among others 1008. For any news, ability is provided to copy 1010, open in another web browser 1011 or add to a reading list to be read and worked on later if required 1012. Corresponding picture-based choices are shown for reading later, opening in another browser. 1013 1014 1015. There is ability to share news from external websites and mobile applications to be shared at intended applications 1009. Financial news is crowdsourced this way also.

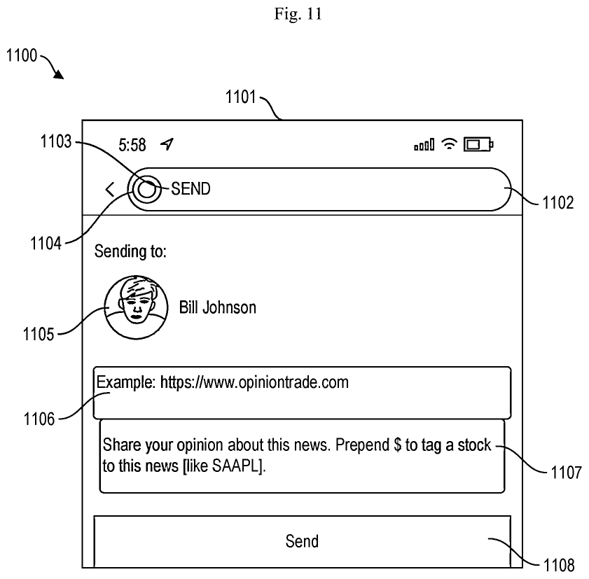

FIG. 11 1100 is an exemplary illustration, in one embodiment, of a mobile or desktop application screenshot 1101. This represents another embodiment of the use of the app by the sender 1103. A user is chosen 1105, and financial news link information is shared for a company 1106. Option to share the news is provided and a “SEND” button provided 1107 1108. This embodiment represents a superimposed window for AAPL or other stock is not yet chosen by the sender and the keyboard superimposed window has not yet appeared. 1106 1107. Standard mobile or desktop icons for wireless connection, location and item are provided 1101. Full flexibility is provided to send appropriate information to the chosen receiver 1108 1103 1104 1105.

FIG. 12 1200 is an exemplary illustration, in one embodiment, of a mobile or desktop application screenshot 1201. This represents a screen shot to show a plurality of news cards assembled by the app, after having scanned, collected through newsfeed and crowdsourced the appropriate financial websites 1204 1209 1213 1216. Option to search a stock is provided and as an exemplary embodiment, trending news are used to form the financial news cards 1202 with option to bookmark 1203. A list of all trending news cards is shown which are scrollable 1204 1209 1213 1216. The financial news cards have stock symbol, send and share buttons and news title 1204 1205 1209 1210 1213 1214. Along with send and share button 1207, ability to start a chat session is also provided 1215. The app provides at the bottom to go to a home screen, get a watch list of stocks, a send screen shot, analytics to show analysis of stocks and invoking a user screen shot to search a user or users 1217. A favorite button is provided to store links to selected stocks 1212. Market sentiments are also provided 1211. Extracted investment news and stocks are based on machine learning and algorithm-based ordering search and sort.

FIG. 13 1300 is an exemplary illustration, in one embodiment, of a mobile or desktop application screenshot 1301. This represents a screen shot to show a plurality of news cards assembled by the app, after having scanned or collected through news feed or crowdsourced the appropriate financial websites 1304 1309 1311. Option to search a stock is provided and as an exemplary embodiment, most read items are used to form the financial news cards 1302 with option to bookmark 1303. A list of all most read items news cards is shown which are scrollable 1304 1309 1311. The financial news cards have stock symbol, send and share buttons and news title 1304 1305 1309 1310 1313 1314. Along with send 1320 and share 1319 button market mover button 1307, ability to start a chat session is also provided 1315. The app provides at the bottom to go to a home screen, get a watch list of stocks, a send screen shot, analytics to show analysis of stocks and invoking a user screen shot to search a user or users 1316. A favorite button is provided to store links to selected stocks 1308. Extracted investment news and stocks are based on machine learning and algorithm-based ordering search and sort.

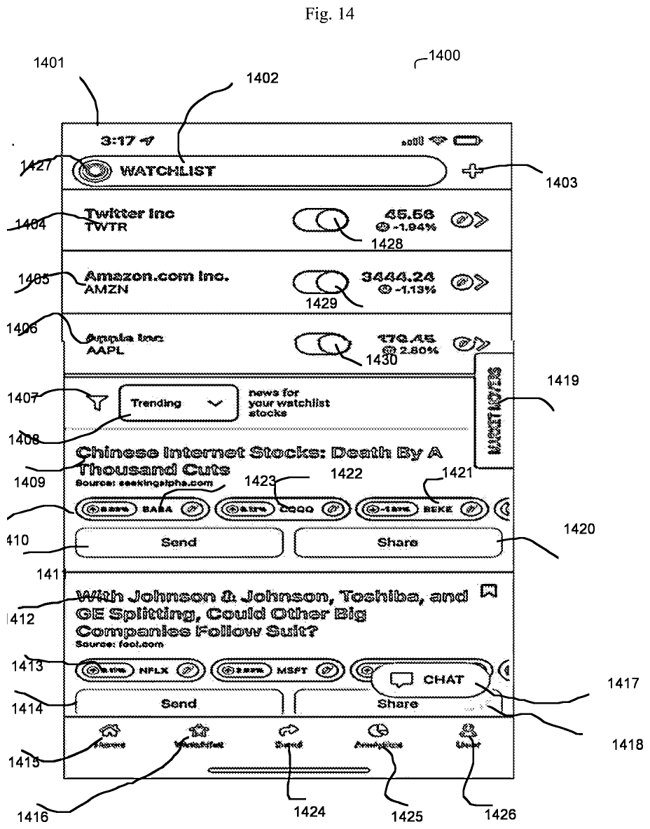

FIG. 14 1400 is an exemplary illustration, in one embodiment, of a mobile or desktop application screenshot 1401. This screen is exemplary representation when “WATCHLIST” 1402 is chosen from the watch list 1416. A list of stocks is displayed on the screen 1404 1405 1406, with the symbol, present value and ability to reach and effectuate a trade if so chosen. The screen 1401 optionally selects either trending, latest or most read news 1408, after organizing and constructing them to news cards as defined within 1409 1412. Each news card presents ability to send 1414 and share 1418. Stocks of interest are displayed on news cards 1421 1422 1423. There is ability to move to “Market Movers” 1419 screen. A filter capability is provided for the news cards 1407. Ability is also provided to move to chat window 1417. At the bottom of the screen, there is ability to return to home 1415, to pick watch list 1416, or go to send screen 1424, analytics 1425 or update user(s) 1426. A button of the app 1,427 is shown on the watch list 1402 window with a “+” sign signifying ability to add stocks on the watch list 1403. An ability is provided to toggle news for a stock 1428 1429 1430.

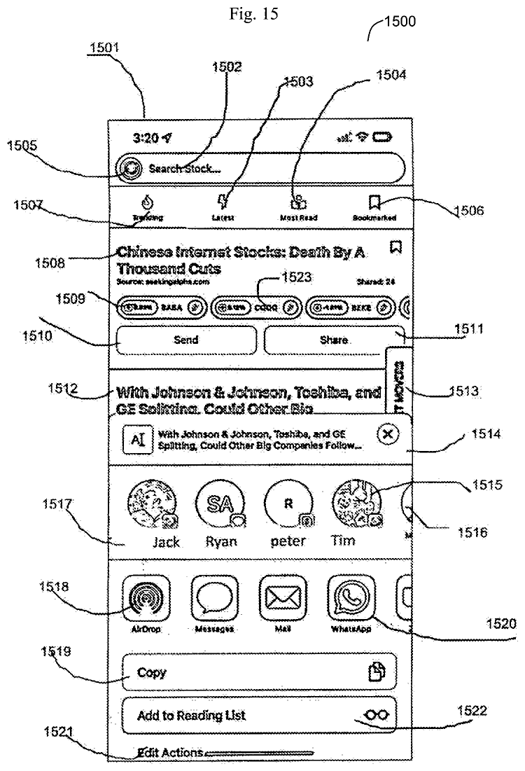

FIG. 15 1500 is an exemplary illustration, in one embodiment, of a mobile or desktop application screenshot 1501. It represents the “SHARE” screen 1501, when it is chosen from the news card in question 1511. Similar to other windows, the app button 1505 and the window identifier are shown 1502, Ability to search additional stocks is provided 1502. Ability to display news cards based on trending, latest, most read and book marked is provided 1507 1503 1504 1506. Based on one of the four choices, the news cards 1508 1512 are shown with stock symbol 1523 1509, its present value and the change from the market's last close 1523 1509. The news cards 1508 1512 provide ability to send 1510 and share 1511. A list of users 1517 is shown in a scrollable fashion within a windowlet (mini window), with user's names displayed 1515 1516. Ability to share on various apps id provided with ability to scroll within a windowlet 1518, with apps of “AirDrop,” “Messaging or Texting,” “Email,” “WhatsApp” and others 1520. Ability to copy news cards 1519, addition to reading list is provided 1522, with option provided to user to be able to edit or change the action set 1521. An ability to move to “MarketMovers” 1513 screen is provided as well. Stock symbols are displayed and provide capability to immediately move to trading sites, if required 1523 1509.

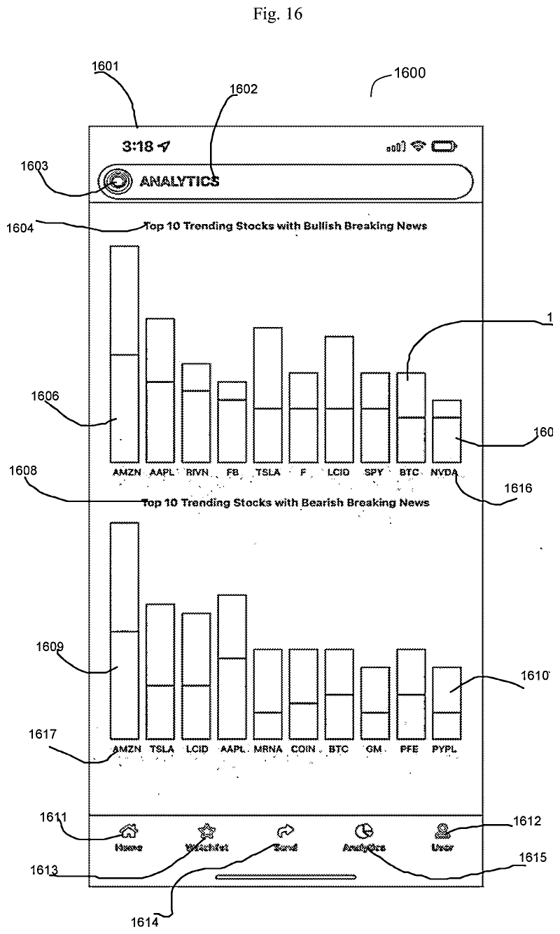

FIG. 16 1600 is an exemplary illustration, in one embodiment, of a mobile or desktop application screenshot 1601. It represents the “ANALYTICS” 1602 window screen when the same if chosen from the home window's bottom windowlet (mini window) 1615. An app button 1603 and window identifier are displayed 1602. Histograms 1606 1609 associated with a chosen set of stocks are displayed in negative 1610 and positive color 1606 codes. Among others, in one embodiment, up to ten stocks are chosen for top trending stocks 1604 1608, as well as whether news on them is bullish 1604 or bearish 1608. Ability to click on stock and access news cards is provided 1610 1609 1606. The news cards provide ability to share, send and move to trading sties to effectuate trade if required 1617 1616. At the bottom, the windowlet provides ability to go back to the home screen 1611, go to watch list 1613, go to send screen 1614, stay on analytics 1615 and or go to user selection screen 1612 with ability to group chat, single chat or send or share news cards.

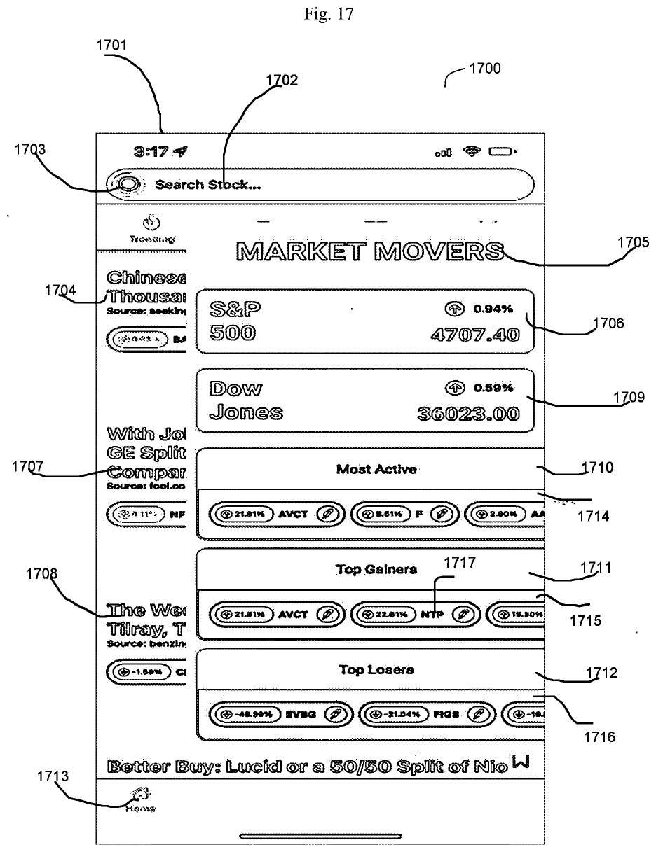

FIG. 17 1700 is an exemplary illustration, in one embodiment, of a mobile or desktop application screenshot 1701. It represents the “MARKETMOVERS” 1705 screen shot. App button 1703 and ability to search stocks is provided 1702. The news card screen shot is shown 1701 over which the MARKETMOVERS windowlet 1705 is superimposed. The news card provides trending, latest, most read or bookmarked stocks news 1704 1707 1708. That window also has an ability to take user to “MARKETMOVERS” window. The market movers window is superimposed 1705, showing current market for S & P 1706 and Dow Jones Industrial 1709 as an exemplary implementation, present value and change from last close. The market movers organize a news card specific to most active stocks 1710, top gainers 1711 and top losers 1712. The stock list is a windowlet 1714 1715 1716, which is individually scrollable to be able to evaluate top certain number of these stocks. Each row displays the stock symbols to be able to move to trading sites of brokers or be able to immediately trade if so desired 1717. There is ability to go to trending, latest, most read news of that stock. Stock can also be added or removed from the watch list. The bottom window, similar to other windows, provides ability to go back to home screen 1713, display analytics, display watch list of stocks and move to single/or group chat session with a chosen set of users.

FIG. 18 1800 is an exemplary illustration, in one embodiment, of a mobile or desktop application screenshot 1801. This represents a screen shot to show a plurality of news cards assembled by the app, after having scanned, collected through newsfeed and crowdsourced the appropriate financial websites and then bookmarked. 1806 Option to search a stock is provided and as an exemplary embodiment. Bookmarked news cards are used to form the bookmarked screen 1805. A list of all bookmarked news cards is shown which are scrollable 1806. The financial news cards have stock symbol, send and share buttons and news title 1806 1807 1816 1817 1818 1819. Along with send and share button 1817 1819, ability to start a chat session is also provided 1810. The app provides at the bottom to go to a home screen, get a watch list of stocks, a send screen shot, analytics to show analysis of stocks and invoking a user screen shot to search a user or users 1811 1812 1813 1814 1815. A favorite button is provided to store links to selected stocks. Market sentiments are also provided. Extracted stocks are based on machine learning and algorithm-based ordering search and sort. Market movers'selection is provided 1809. Stock trading mechanism is provided with current valuation shown. 1820 1821.

FIG. 19 1900 is an exemplary illustration, in one embodiment, of a mobile or desktop application screenshot 1922. This represents a screen shot to show a plurality of news cards assembled by the app, after having collected through newsfeed, crowd sourced and scanned the appropriate financial websites 1906 1909 1910 1911. Option to search a stock is provided and as an exemplary embodiment, “latest” are used to form the financial news cards 1903 with option to bookmark 1905. A list of latest items news cards is shown which are scrollable 1906 1909 1910 1911. The financial news cards have stock symbol, send and share buttons and news title 1920 1921 1907 1908. Along with send 1907 and share 1908 button market mover button 1914, ability to start a chat session is also provided 1912. The app provides at the bottom to go to a home screen, get a watch list of stocks, a send screen shot, analytics to show analysis of stocks and invoking a user screen shot to search a user or users 1915 1916 1917 1918 1919. A favorite button is provided to store links to selected stocks 1913. Extracted stocks and investment news are based on machine learning and algorithm-based ordering search and sort.

Embodiments as described herein as a framework system are exemplary. The examples provided above are illustrative only and are not intended to be limiting. One skilled in the art may readily devise other systems consistent with the disclosed embodiments which are intended to be within the scope of this disclosure. Although the present invention has been explained in relation to its preferred embodiment of financial trading instruments (stock as an exemplary instance), it is to be understood that many other possible modifications and variations can be made without departing from the spirit and scope of the invention as herein described.

Further discussion of Financial News Card types of Virtual Cards

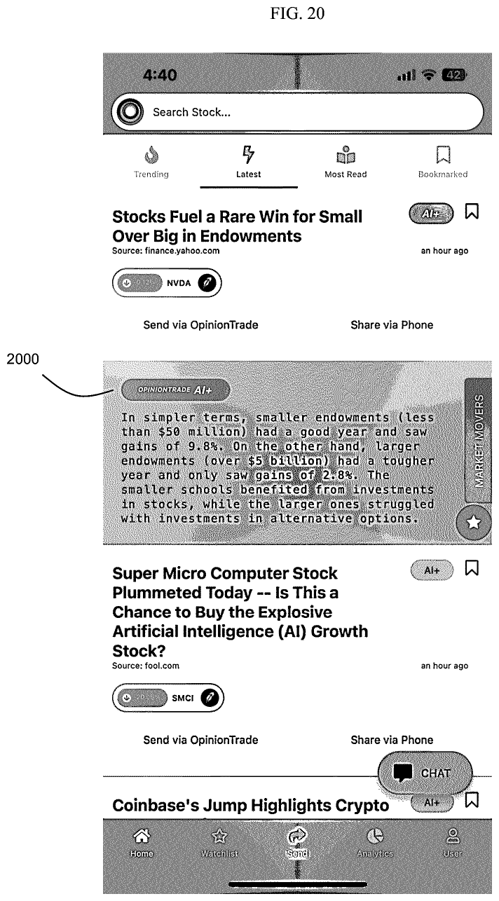

In some embodiments, the financial news card may have payload that comprises one or more data structures comprising multiple data fields, such as, but not limited to:
1. News Title: Each financial news card may comprise a data field with a clickable title that directs the user to the full news article. This title may also serve as a hyperlink, enabling seamless access to the complete content.
2. News Link: News Link is data field may be preserved for the finance and investment news.
3. News Source: The financial news card has a news source data field that may be used to prominently displays the name of the website where the news originated. This information provides users with the source's credibility and may also assists in verifying the authenticity of the news.
4. AI+ Summary: The financial news card incorporates an Artificial Intelligence+ (AI+) Summary data field. This can be an Artificial Intelligence (AI)-generated data field that contains a concise summary of the entire news article. This summary can have a defined field length, such as is around 100 words or more, depending upon the news, thus allowing users to quickly grasp the key points of the news content. An example of such an AI+ summary is shown in FIG. 20 (2000).
5. Stock-buttons of associated stocks: The financial news card can further comprise stock button data fields. These “stock buttons” contain the names or symbols of the stocks associated with a particular news article. This scheme enables system users to access information such as stock symbol, stock company name, stock prices, and perturbations in stock price, add stocks to a watch list, explore trending news for a specific stock, access the latest news related to the stock, and utilize trading options available on different websites. In some embodiments, the users can also examine stock prices and perform other types of stock analysis as well.
6. Count: The count data field enables the financial news card to also display the number of times it has been shared, the time of sharing, and the number of times it has been read. This information provides insights into the popularity and engagement level of that particular financial news card.
7. Send button (to send a financial news card): This data field essentially links a given card to a contact list. As a result, when a user clicks on the “Send” option, the system has the information needed to direct the user to a contact list. From there, the user can select a recipient to whom they wish to send a financial news card (for example, via chat). In some embodiments, the system can be configured so that it subsequently creates a new financial news card. This new financial news card allows the user to add their comments and associate these comments with a given a stock (for example by using a “$” symbol). This newly activated financial news card, with the user's comments and associated stock link, is then sent to the chosen recipient or group.
8. Share Button (to share a financial news card): In some embodiments, the system may be configured so that users can select a “Share” or “Export” functionality for a financial news card. This would enable the user to share the news on various external platforms such as Skype, Facebook, Linked, and others. This sharing or “exporting” may often export a simplified presentation of the financial news card, with some data fields not exported. Exported financial news card data fields will often include the link and title, however, making it convenient for users to disseminate the news across different networks.
9. Users can bookmark financial news card from trending, latest, chat card, or most read news and access them later in bookmarked financial news cards sections.

1. A computerized system comprising:
A virtual card server for a domain of interest comprising at least one server processor, server memory, server internet interface, and a machine intelligence engine;
a plurality of user computerized devices, each comprising at least one device processor, device internet interface, and graphical user interface;
said virtual cards comprising news card information, said news card information comprising at least one transmitting user identification, at least one receiving user distribution, a title, priority, card payload data, machine-learning-enhanced presentation data, user interest flag, and at least one user command;
wherein said virtual card server is configured to exchange virtual cards by receiving virtual cards over said server internet interface, examining the card's receiving user information, and transmitting said virtual card over said server internet interface to the corresponding user computerized device;
wherein any of said user computerized devices receive a virtual card assigned to their user on said device internet interface, said at least one device processor is further configured to process said virtual card, and display at least some of said virtual card's said news card information on said graphical user interface; and
wherein at least some of said user computerized devices are configured to use their graphical user interface device to receive input data and use their device processor and device network interface to generate a virtual card and transmit said virtual card to said virtual card server; and
wherein said virtual card server is further configured to receive at least one news feed data stream reporting on said domain of interest;
wherein said machine intelligence engine is configured to store a history of said at least one news feed data stream, history of past exchanges between said users, said titles, said user interest flags, and said payload data, and use this to train said machine intelligence engine to predict and influence any of the receiving user distribution, priority, or machine-learning-enhanced presentation data of said virtual card before transmitting said virtual card over said server internet interface.

2. The system of claim 1, wherein said machine intelligence engine is a large language model (LLM) configured for at least a general-purpose Artificial Intelligence (AI);
said LLM comprising a plurality of multiple neural network layers;
wherein said multiple neural network layers and said LLM are trained for said domain of interest.

3. The system of claim 2, wherein said graphical user interface is an AI-enhanced graphical user interface, and said user computerized device is further configured to display at least some of said virtual card's said news card information on said graphical user interface according to any of said receiving user distribution, priority, or machine-learning-enhanced presentation data.

4. The system of claim 3, wherein said machine intelligence engine is further configured by neural network training to determine if certain types of news feed data stream items correlate, for at least certain users, with higher amounts of user interest flags as being news items of potential user interest; and
wherein said virtual card server is configured to transmit at least some of said news feed data stream to said machine intelligence engine;
Said machine intelligence engine uses at least some of said news feed data stream to determine if there is a correlation with said news items of potential user interest and
wherein said virtual card server is further configured to transmit said news items of potential user interest to said user computerized devices for display on said AI-enhanced graphical user interface.

5. The system of claim 1, wherein said virtual card server is configured to examine said at least one user command and when at least one of said at least one user command is not null and directed to a third-party server system, transmit said at least one user command to said third-party server system.

6. The system of claim 5, wherein said commands comprise financial instrument transaction commands and said third-party system is configured to execute said transactions.

7. The system of claim 6, the system of claim 1, wherein said domain of interest comprises any of economics, business, and stock investing.

8. The system of claim 7, wherein said virtual card server is configured as both a financial investment framework system and as a social network.

9. The system of claim 1, wherein said graphical user interface is configured to enable at least one human user to enter any of said title, priority, card payload data, user interest flag, and at least one user command.

10. A method comprising:
configuring a virtual card server for a domain of interest, said virtual card server comprising at least one server processor, server memory, server internet interface, and a machine intelligence engine;
said virtual card server configured to exchange virtual cards with a plurality of user computerized devices, each comprising at least one device processor, device internet interface, and graphical user interface;
said virtual cards comprising news card information, said news card information comprising at least one transmitting user identification, at least one receiving user distribution, a title, priority, card payload data, machine-learning-enhanced presentation data, user interest flag, and at least one user command;
using said virtual card server to receive virtual cards over said server internet interface, examining the card's receiving user information, and transmitting said virtual card over said server internet interface to the corresponding user computerized device;
receiving, at any of said user computerized devices, at least one virtual card assigned to their user on said device internet interface;
processing said virtual card using said at least one device processor and displaying at least some of said virtual card's said news card information on said graphical user interface;
using the graphical user interface of at least some of said user computerized devices to receive input data and using their device processor and device network interface to generate a virtual card and transmit said virtual card to said virtual card server;
receiving at least one news feed data stream reporting on said domain of interest at said virtual card server;
wherein configuring said virtual card server for said domain of interest is done by training said machine intelligence engine using a history of said at least one news feed data stream, history of past exchanges between said users, said titles, said user interest flags, and said payload data;
wherein said training further configures said machine intelligence engine to predict and influence any of the receiving user distribution, priority, or machine-learning-enhanced presentation data on received virtual cards, producing modified received virtual cards, before subsequently transmitting said modified received virtual cards over said server internet interface.

11. The method of claim 10, wherein said machine intelligence engine is a large language model (LLM) configured for at least a general-purpose Artificial Intelligence (AI);
said LLM comprising a plurality of multiple neural network layers;
wherein said multiple neural network layers and said LLM are trained for said domain of interest.

12. The method of claim 11, wherein said graphical user interface is an AI-enhanced graphical user interface, and said user computerized device is further configured to display at least some of said virtual card's said news card information on said graphical user interface according to any of said receiving user distribution, priority, or machine-learning-enhanced presentation data.

13. The method of claim 12, further configuring said machine intelligence engine by neural network training to determine if certain types of news feed data stream items correlate, for at least certain users, with higher amounts of user interest flags as being news items of potential user interest; and
using said virtual card server to transmit at least some of said news feed data stream to said machine intelligence engine;
wherein said machine intelligence engine uses at least some of said news feed data stream to determine if there is a correlation with said news items of potential user interest and
transmitting, using said virtual card server, said news items of potential user interest to said user computerized devices for display on said AI-enhanced graphical user interface.

14. The method of claim 10, further using said virtual card server is to examine said at least one user command and when at least one of said at least one user command is not null and directed to a third-party server system, transmitting said at least one user command to said third-party server system.

15. The method of claim 14, wherein said commands comprise financial instrument transaction commands and said third-party system is configured to execute said transactions.

16. The method of claim 15, the method of claim 1, wherein said domain of interest comprises any of economics, business, and stock investing.

17. The method of claim 16, further configuring said virtual card server is as both a financial investment framework system and as a social network.

18. The method of claim 10, further using said graphical user interface to allow human entry of any of said title, priority, card payload data, user interest flag, and at least one user command.
